(19) United States
(12) Patent Application Publication
(10) Pub. No.: US 2016/0184183 A1
(43) Pub. Date: Jun. 30, 2016

(54) Packaged Iron Sucrose Products

(71) Applicant: Hospira, Inc., Lake Forest, IL (US)

(72) Inventors: Seshagiri R. Tata-Venkata, Chicago, IL (US); Xifeng Zhang, Gurnee, IL (US); Fay Goldblatt, Wilmette, IL (US); Minhaj Siddiqui, Lake Villa, IL (US)

(21) Appl. No.: 15/063,049

(22) Filed: Mar. 7, 2016

Related U.S. Application Data
(63) Continuation of application No. 12/993,592, filed on Jun. 3, 2011.
(60) Provisional application No. 61/055,648, filed on May 23, 2008.

(51) Int. Cl. A61J 1/14; B65B 3/00; B65D 65/42

(52) U.S. Cl. CPC A61J 1/1468; B65D 65/42; B65B 3/003

(57) ABSTRACT

A packaged iron sucrose formulation including a container with an interior glass surface that is coated with layer of material containing silicon, such as a silicone polymer or silicon dioxide. The iron sucrose formulation is packaged inside the glass vessel and in contact with the layer of material containing silicon. The packaged formulation can be stored for extended periods without glass delamination.

### BACKGROUND OF THE INVENTION

1. Field of the Invention

The invention is generally related to pharmaceutical products. The invention is more particularly related to iron sucrose products in containers having glass as a primary component.

2. Description of Related Art

Glass is currently the preferred material for packaging parenteral pharmaceutical solutions due to its chemical and physical inertness. While this presumption generally holds true, glass under certain conditions is both chemically and physically reactive. It has long been known that aqueous solutions can interact with glass leading to the formation of glass-based particulate matter. This process, known generally as glass delamination, is accelerated by solutions containing various anions, especially under alkaline conditions, or by exposure to high temperatures, such as those used during terminal sterilization.

Manufacturers have undertaken efforts to address glass delamination. For example, lower heat exposure and longer manufacturing times have been used to produce glass products that are more resistant to the delamination process. The cost of glass vials produced using this process is greater than standard glass vials since a lower heat exposure requires increased manufacturing time. The use of chemically treated glass, such as ammonium sulfate treated glass, has also been purported to produce glass products that are more resistant to delamination.

Iron sucrose is an aqueous complex of polynuclear iron (III) hydroxide in sucrose for intravenous use. Following administration, iron sucrose is dissociated by the reticuloendothelial system. Iron sucrose is administered to raise the patient's hemoglobin levels, and may be used in cases of oral iron therapy intolerance or ineffectiveness. Hypersensitivity reactions are believed to be less common with iron sucrose compared to other parenteral iron products. Iron sucrose can be used for the treatment of iron deficiency anemia, for example in peritoneal dialysis and hemodialysis dependent patients receiving erythropoietin therapy and non-dialysis dependent, chronic kidney disease patients. Iron sucrose has also been suggested for use in the treatment of restless leg syndrome.

At a conventionally-packaged concentration (20 mg elemental iron/mL), iron sucrose is very dark brown in color, and is effectively opaque as packaged. Certain conventional formulations of iron sucrose are high in pH (e.g., pH values of 10.5-11), and have an osmolarity of 1250 mOsmol/L. These formulations can be diluted with 0.9% sodium chloride to provide a therapeutically-desired concentration.

Iron sucrose is conventionally packaged in glass. Glass vessels are known to be air-impermeable, and therefore protect the iron sucrose from oxidation. Generally, glass containers are visually inspected for sediment and damage before use. Only those containing a sediment free and homogeneous solution should be used. Because iron sucrose is a dark opaque solution, the presence of glass particulate as the result of delamination is not readily recognized by visual inspection alone. Also, the light obscuration technique is not sensitive enough to detect the delaminated particles in iron sucrose formulations due to the inherent opacity of the solution.

Delaminated glass particles can be identified using, among other methods, scanning electron microscopy equipped with an energy dispersive X-ray analyzer (SEM/EDS). Scanning electron microscopy (SEM) can also be used to map the surface morphology within glass vials and to screen surface integrity. Glass surfaces can be characterized by SEM before and after exposure to drug product. Additionally, solutions can be filtered through an appropriate filter membrane and the retained glass particulates can be detected using the SEM technique. However, these methods of detection of glass delamination are impractical for routine inspection of commercially packaged iron sucrose solutions.

The inventors have determined that iron sucrose formulations packaged in conventional glass vessels can develop glass particulates over time due to the delamination of glass from the interior glass surface. Accordingly, the inventors have identified a need in the art to provide a glass package for iron sucrose solutions that avoids glass delamination.

### SUMMARY OF THE INVENTION

One aspect of the invention involves a packaged iron sucrose product including a container constructed from a material including glass, the container having an inside surface having formed thereon a layer of a material containing silicon dioxide or a silicone polymer. Inside the container is an iron sucrose formulation in contact with the layer of the material.

In various aspects of the invention, the iron sucrose formulation is an aqueous formulation, such as iron sucrose and water for injection. The solution may have a pH of 9 or greater. The iron concentration may be in the range of 0.1 mg/mL to 50 mg/mL.

In other aspects, the material coating the interior inside surface of the container includes a polyalkylsiloxane, such as polydimethylsiloxane, having a thickness of about 150 nm to about 50 μm. Also, a silicon dioxide layer may have a thickness in the range of about 50 nm to about 20 μm.

A further aspect of the invention is directed to a method for storing an iron sucrose formulation. The method includes packaging a high pH iron sucrose in a container according to the invention.

### BRIEF DESCRIPTION OF THE FIGURES

FIG. 1 is cross-sectional view of a pharmaceutical product constructed in accordance with the present invention.

FIGS. 2A-2D are SEM photographs of delaminated glass flakes collected on filter paper and obtained from individual containers of VENOFER® Iron Sucrose Injection, USP. Samples were obtained five months prior to product expiration from containers stored at room temperature.

FIGS. 3A-3D are SEM photographs of delaminated glass flakes collected on filter paper and obtained from individual containers of VENOFER® Iron Sucrose Injection, USP. Samples were obtained eighteen months prior to product expiration from containers stored at room temperature.

FIG. 4 is an SEM photograph of glass flakes collected on filter paper and obtained from a solution of Iron Sucrose Injection, USP, packaged in a USP Type 1 glass container (tubing vial) stored for 2 months at 25° C.

FIG. 5 is an SEM photograph of glass flakes collected on filter paper and obtained from a solution of Iron Sucrose Injection, USP, packaged in a USP Type 1 tubing vial and stored at 25° C. for 12 months.

FIG. 6 is an SEM photograph of filter paper used to filter a solution of Iron Sucrose Injection, USP, that was packaged in a CARPUJECT® syringe and stored for 12 months at room temperature. The CARPUJECT® container is a USP Type I glass container that is coated with silicone.

FIG. 7. is an SEM photograph of filter paper used to filter a solution of Iron Sucrose Injection, USP, that was packaged in a Wheaton siliconized USP glass container (molded vial) that was stored for 3 months at 40° C.

FIG. 8. is an SEM photograph of filter paper used to filter a solution of Iron Sucrose Injection, USP, packaged in a SCHOTT siliconized USP glass tubing vial and stored for 3 months at 40° C.

FIG. 9. is an SEM photograph of filter paper used to filter a solution of Iron Sucrose Injection, USP, that was packaged in a SCHOTT TYPE I PLUS silcon dioxide (SiO₂) coated glass container made from tubing glass and stored for 2 months at 25° C.

### DETAILED DESCRIPTION

In one aspect, the invention is related to the use of a glass vessel for the packaging and storage of iron sucrose formulations. The interior surface of the vessel is coated with a layer of a material containing silicon, such as silicon dioxide or a silicone polymer. The packaged products and storage methods of the invention provide iron sucrose formulations in a storage stable container that reduces or prevents the formation of glass particulate matter over the storage life of the product.

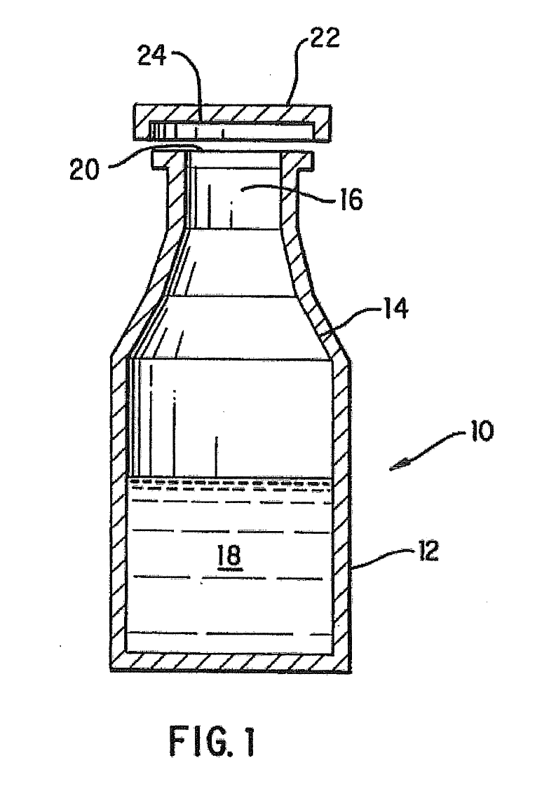

A packaged iron sucrose product can be constructed in accordance with the invention as generally depicted in FIG. 1. Product 10 includes container 12 having an interior surface 14. Interior surface 14 defines an interior space 16 within container 12. An iron sucrose formulation 18 is contained within interior space 16 of container 12. In one embodiment of the invention, formulation 18 is at or above a pH of approximately 9.

As depicted in FIG. 1, container 12 defines an opening 20. Opening 20 facilitates the filling of container 12 and provides access to the contents of container 12, thereby allowing the contents to be removed from container 12 when they are needed. In the embodiment of the present invention depicted in FIG. 1, opening 20 is a mouth of a bottle or vial. However, it will be appreciated that opening 20 can have a variety of known configurations without departing from the scope of the present invention.

In various aspects of the invention, the glass vessel is made from a material that includes glass, which is used herein in its ordinary sense. Examples of materials include soda-lime glass, borosilicate glass, or fused silica. Numerous other types of specialty glass are available including materials where glass is not 100% of the composition. All of these materials are contemplated as appropriate materials for a container for iron sucrose that can be coated with a material containing silicon.

In one aspect of the invention, the material forming the layer on the interior surface of the container is semi-inorganic polymer based on the structural unit R₂SiO, where R is an organic group, for example alkyl, characterized by wide-range thermal stability, high lubricity, extreme water repellence, and physiological inertness. One of the most common polymers is polydimethylsiloxane (PDMS), where R is methyl. Other silicone polymers where R is other alkanes are readily available. In addition, R can be a functionalized moiety that can be cross-linked in situ on the interior surface of the container. Many silicone polymers will work as long as polymer layer can be rendered pharmaceutically compatible and inert to high pH iron sucrose formulations following application of the polymer to the surface. Materials containing silicone may include co-polymers of polyalkylsiloxanes and other compounds which render the inside of the container pharmaceutically compatible and inert to the formulations, and which reduce or prevent the incidence of delamination of the underlying glass.

In another aspect of the invention, the material forming the layer on the interior surface of the container is a silicone polymer, also known as silicone oil. Suitable polymers include, for example, PDMS, alpha-trimethylsilyl)-poly (oxy(dimethylsilylene))-omega-methyl, and dimethylpolysiloxane hydrolyzate. Commercially available examples of such materials include materials in the Baysilon family of silicone polymers (Bayer AG), and Dow Coming® Medical Fluids (Dow Corning, Midland, Mich.), such as Dow Corning® 360 and 365 Medical Fluids.

The process for coating the polymer on the interior surface of the container should be complete enough, and provide a thick enough coating, to minimize or eliminate the presence of pinholes in the coating. For example, a layer of silicone polymer can have a thickness in the range of 150 nm to 50 μm, more particularly from about 1 μm to about 35 μm, and even more particularly about 5 μm to 25 μm.

A common method for applying a silicone polymer to a surface includes diluting Dow Coming® 360 Medical Fluid to 0.1-5% and then using this solution for rinsing, dipping or spraying containers. The solution can be diluted in aliphatic (e.g. hexane, or preferably heptane) and aromatic (e.g. toluene or xylene) solvents. Certain chlorinated solvents can also be used. Dow Coming® Q7-9180 Silicone Fluids (volatile short-chain linear polydimethylsiloxanes) are particularly suitable for diluting Dow Coming® 360 Medical Fluid where good results can be obtained due to, in part, the silicone oil/silicone solvent compatibility.

Another suitable fluid for coating the interior of a glass vial is Dow Coming® 365 Medical Fluid, which is an emulsion composed of 35% Dow Coming® 360 Medical Fluid in water with non-ionic surfactants, Tween®20 and Triton®X-100, and preservatives, sodium benzoate and parabens (propyl and methyl p-hydroxy-benzoates). For application to glass surfaces, this emulsion can be further diluted with sterile, pyrogen-controlled (WFI) water to a concentration of 0.1-5.0% silicone in the final treatment solution. The solution can be applied to surfaces by known methods of rinsing, dipping or spraying. Delivery to the surface of just enough silicone to achieve a uniform coating is sufficient.

Fourier-Transform Infrared Spectroscopy (FTIR) has been used to quantify the amount of silicone fluid applied to an article. However, this method generally requires that the PDMS from a number of articles be extracted in order to get enough PDMS to quantify from the spectrum and standards that must be used. This does not therefore generally allow exact determination of the amount applied to any one article. Another more specific method is Flame Atomic Absorption Spectroscopy (FAAS) which quantifies Si based on a standard curve. FAAS may also require multiple articles be extracted to achieve sufficient concentration to make a determination. Comparative testing of siliconized versus non-siliconized items is another method of qualitative and quantitative assessment.

As part of certain aspects of the invention, a layer of material is formed on the interior glass surface of a container. While some studies suggest that heat treatment can result in a small percentage of fluid to become bound to the surface, it is generally considered that the material can be removed from the surface with appropriate solvents and detergents.

In one embodiment of the invention, the container is heated following the application of the silicone polymer to ensure complete removal of any solvents and to allow the silicone fluid to become more intimately associated with the substrate. The input heat energy assists small aggregates or droplets of the fluid to spread out evenly over the surface and create a more uniform film. At the same time the moisture present on the surface of an article due to humidity from the air is displaced. Heating or baking is done at a temperature and over a time sufficient to remove this moisture from the surface. It is understood that no chemical bonding results. Rather, a strong physical attraction between the surface and initial monolayer of fluid is created. The amount of silicone fluid required is only that needed to achieve a uniform coating of the silicone. The interior surface of the container itself should be clean and free of contaminants before treatment. In one aspect, the baking temperature is kept below 150-350° C. Temperatures at the lower end of the range will minimize any possibility of oxidation and/or the formation of formaldehyde. The time needed for baking is related to the temperature used, usually 20-120 minutes, and can be substantially shortened at higher temperatures. One skilled in the art can readily perform time/temperature studies in order to identify the optimum conditions for the container being siliconized. Some increase in durability or decrease in mobility can be achieved by using a fluid with a higher viscosity. Higher viscosity fluids will not flow as easily across a surface (migrate) and will not tend to be removed into suspension as easily as lower viscosity fluids. The relative number of repeating siloxane units in the polymer chain will determine the molecular weight and viscosity of a particular fluid. As the number of units increases the polymer obviously becomes longer and the viscosity also increases.

Another method for coating a surface with a polymer includes using a polymer having a functional group that renders the polymer capable of being cross-linked in situ upon activation of the polymer by, for example, heating or irradiation. In accordance with this method, the polymer is sprayed or otherwise applied to the inside surface of a container by any conventional method and subjected to an activation step of heating or irradiation.

In another embodiment of the invention, the glass treatment entails the formation of a layer of silicon dioxide material. The silicon dioxide material is SiO_{2 (>}95%, or even >99%). In certain embodiments of the invention, the silicon dioxide material is substantially pure SiO₂. The silicon dioxide layer can be formed, for example, by a vapor deposition process. The layer of silicon dioxide can have a thickness, for example, in the range of 50 nm to 20 μm. In certain embodiments of the invention, the layer of the material covers substantially the entire interior surface of the storage container. As an example, SCHOTT TYPE I PLUS® glass containers are made of pharmaceutical Type I glass having a chemically bonded, substantially invisible, ultrathin layer (0.1-0.2 μm) of pure SiO₂ on their inner surface. As a result, loss of active components due to adsorption, degradation, etc. is significantly reduced. The container can be washed, depyrogenated, filled and sterilized.

Iron sucrose mixtures include, for example, water and polynuclear iron (III) hydroxide in sucrose. In one embodiment of the invention, the iron sucrose mixture has a pH greater than 7, more particularly greater than about 9.0 and even more particularly greater than about 10.5. The iron concentration (measured as elemental iron) can be, for example, in the range of 0.1 mg/mL to 50 mg/mL. In one embodiment of the invention, the iron concentration is in the range of 0.1 mg/mL to 10 mg/mL. In another embodiment of the invention, the iron concentration is in the range of 5 mg/mL to 50 mg/mL. For example, the aqueous iron sucrose mixture can have a pH in the range of 10.5-11 and an iron concentration of about 20 mg/mL, as in a commercial product marketed under the trademark VENOFER® (American Reagent, Inc., Shirley, N.Y.). In certain embodiments of the invention, the aqueous iron sucrose mixture includes only iron sucrose and water for injection. In one aspect, the aqueous iron sucrose mixture is substantially free of proteins, dextran or other polysaccharides or preservatives (e.g. benzyl alcohol).

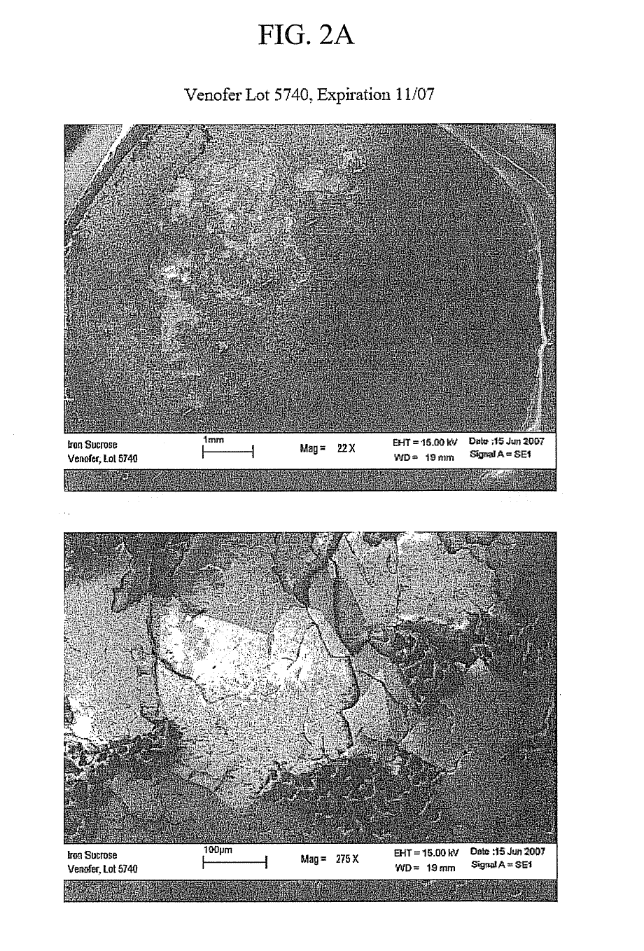

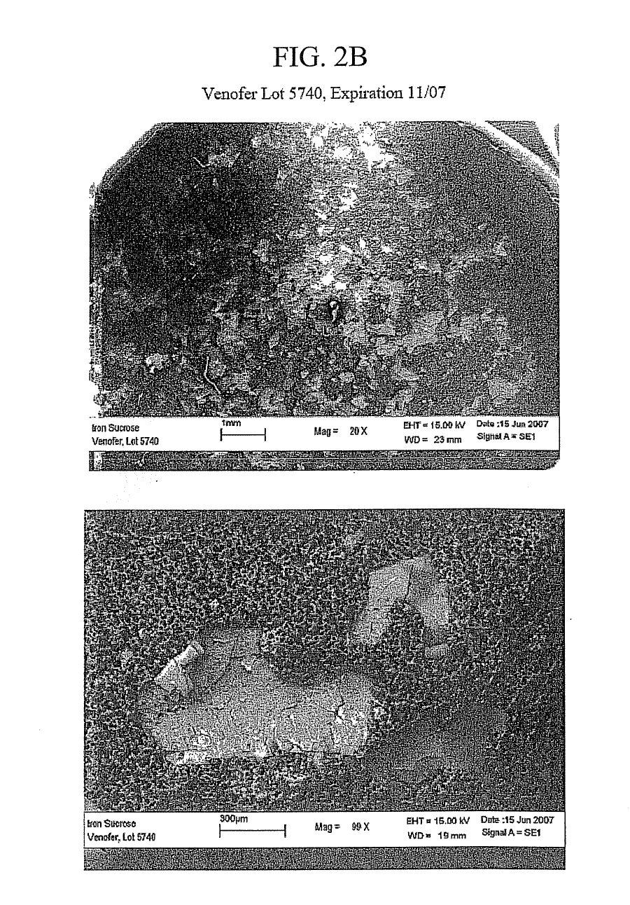

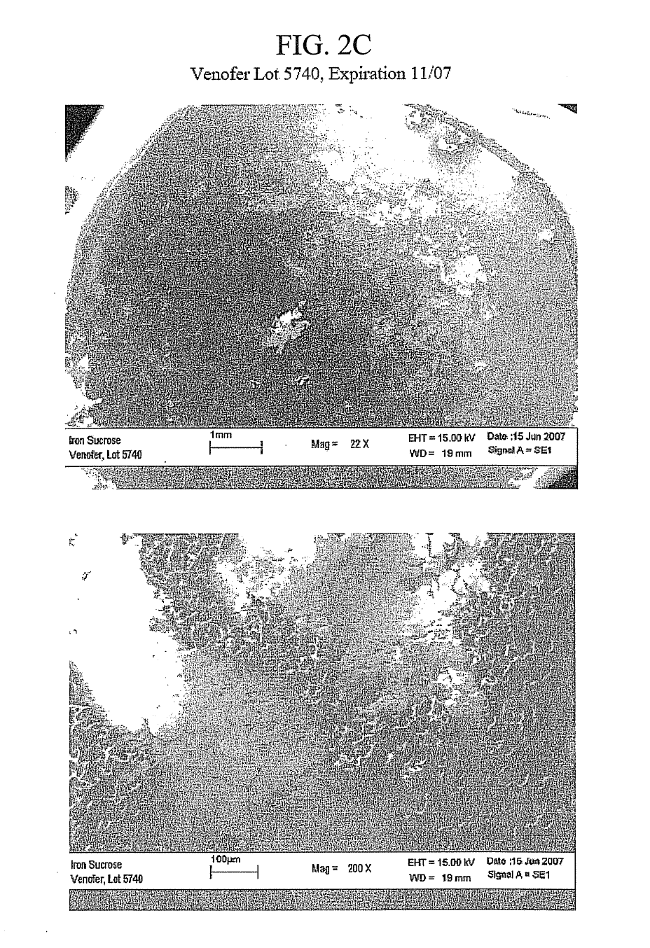

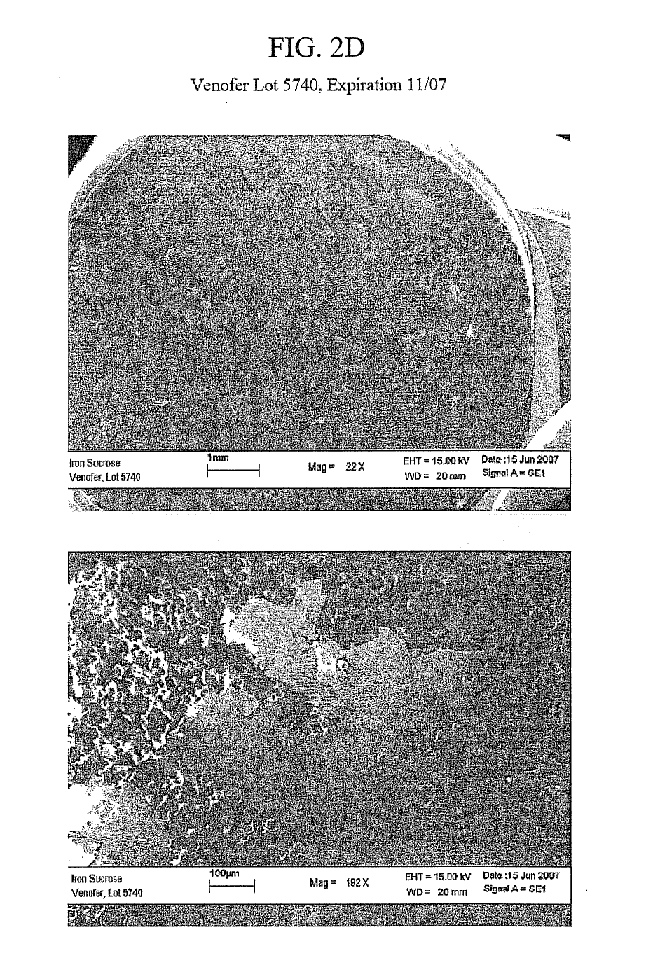

Glass delamination in each of the containers can be assessed by filtering the solution and observing the glass flakes under scanning electron microscopy. Particulates identified as glass are further tested for elemental analysis. For example, FIGS. 2-9 are SEM photographs of filter paper used to collect the solid contents of individual vials of iron sucrose formulations using a 0.45 micron polycarbonate filter. The photographs of the filter paper and the filtrate are shown at various magnifications. Using this method, the inventors have identified particulate flakes having a diameter from 1 μm to about 1000 μm in iron sucrose formulations packaged in conventional glass packages. Depending upon the size and number of flakes that can be counted, a relative extent of glass delamination can be obtained. The presence of sodium, potassium, oxygen, aluminum and silicon in the flakes is also indicative of delamination.

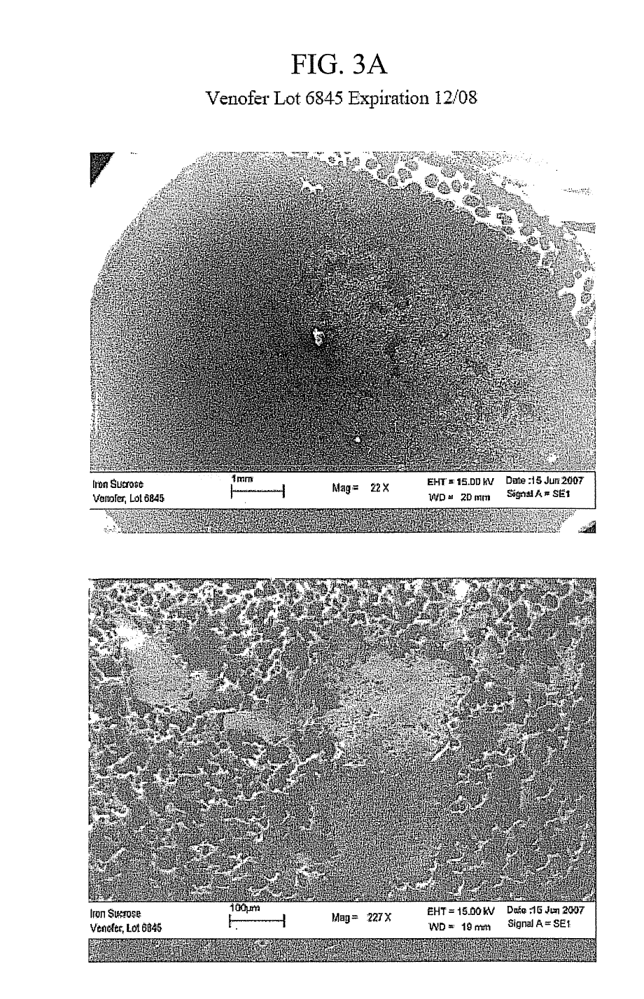

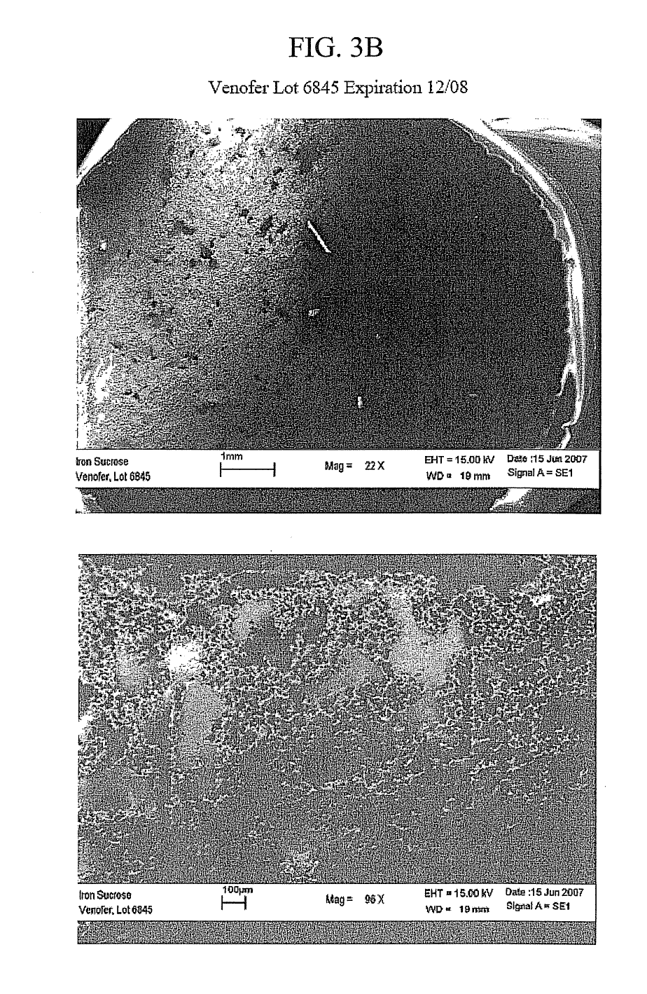

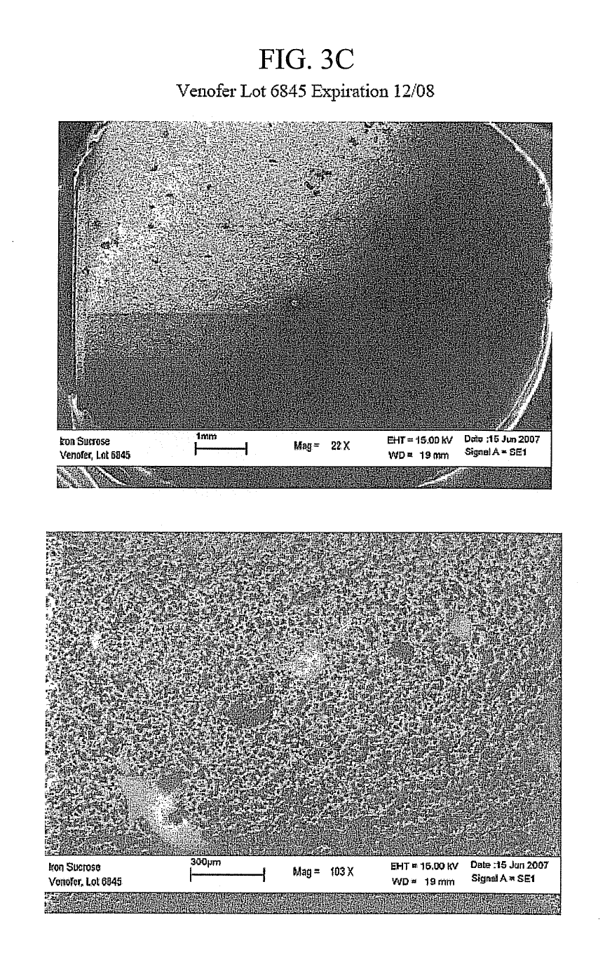

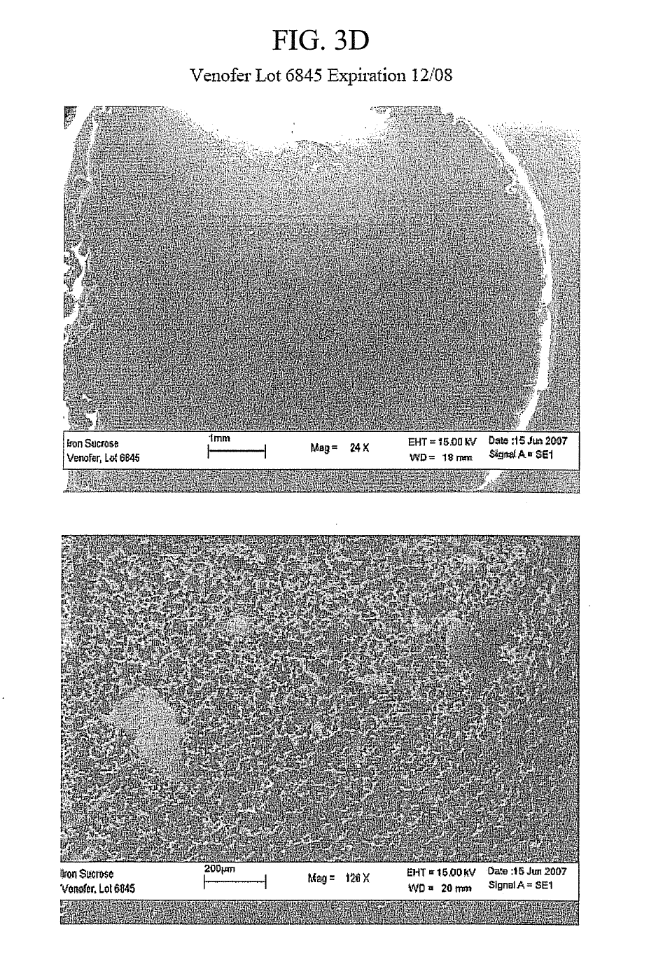

FIGS. 2A-2D are SEM photographs of filter paper that collected the glass flakes from individual containers of VENOFER® iron sucrose formulation. The photographs show, at various magnifications, the development of glass particulate matter in samples at 5 months prior to the expiration of the formulation. FIGS. 3A-3D are SEM photographs of filter paper that collected the glass flakes from individual containers of VENOFER® iron sucrose formulations at various magnifications, in samples 18 months prior to expiration. The newer samples of FIGS. 3A-3D showed glass flakes but to a lesser extent than the sample shown in FIGS. 2A-2D.

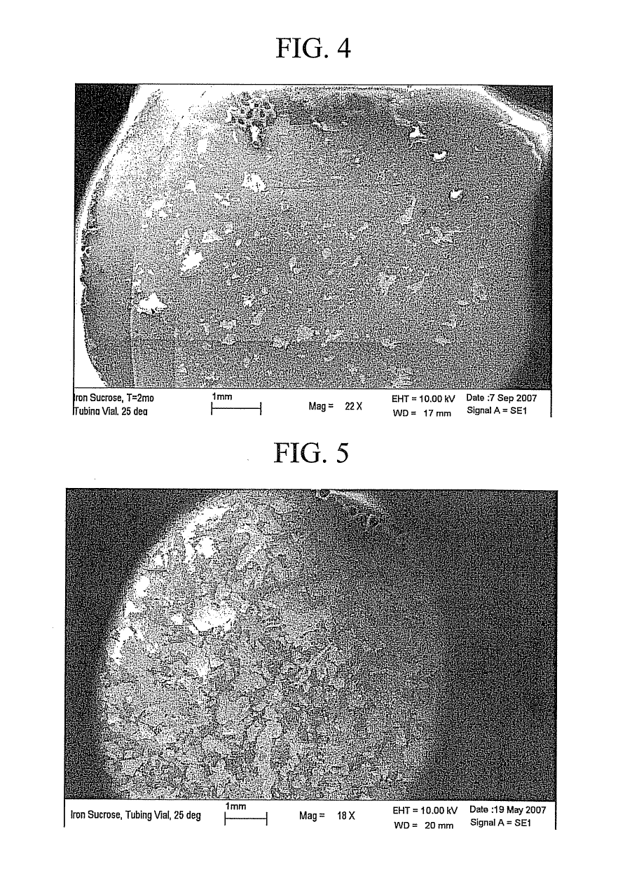

FIGS. 4 and 5 are SEM photographs of the filter paper that collected the glass flakes from an untreated tubing vial used for storage of a high pH iron sucrose formulation. In FIG. 4, the formulation was stored in the vial for 2 months at 25° C. In FIG. 5, the formulation was stored in the vial for 12 months at 25° C. The difference in the number of flakes that developed between 3 and 12 months is apparent from the photographs.

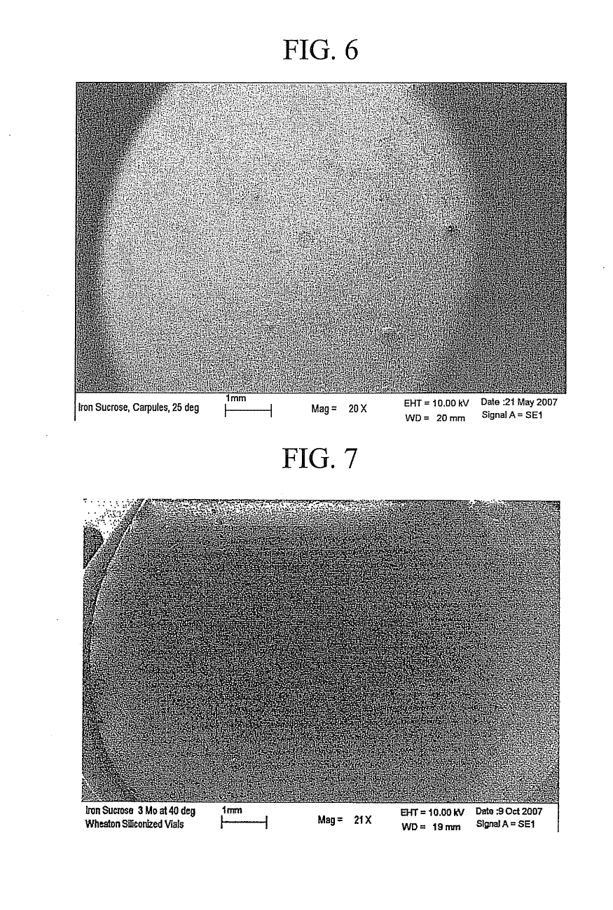

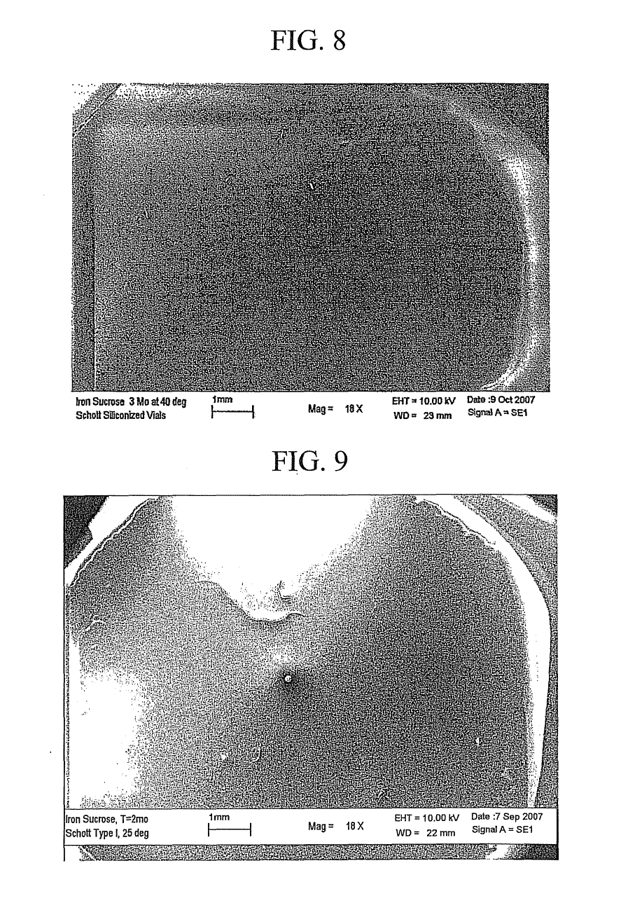

FIGS. 6-9 show the filter paper that was used to filter the contents of siliconized containers according to the present invention. FIG. 6 shows absence of glass flakes in a CARPUJECT® glass container treated with a silicone polymer that contained an iron sucrose formulation for 12 months at room temperature. FIG. 7 shows the absence of glass flakes in a solution of an iron sucrose injection packaged in a Wheaton siliconized USP glass container (molded vial) that was stored for 3 months at 40° C. FIG. 8. shows the absence of glass flakes in a solution of Iron Sucrose Injection, USP, packaged in a SCHOTT USP siliconized glass container (glass tubing vial) and stored for 3 months at 40° C. FIG. 9 shows glass flakes from a SCHOTT TYPE I PLUS® glass container that stored the formulation for 2 months at 25° C.

In one embodiment of the invention, after filling the glass vessel with the iron sucrose formulation, the iron sucrose formulation remains in the glass vessel for an extended period of time without measurable glass delamination. For example, the aqueous iron sucrose formulation can be left in the glass vessel for at least several weeks, and preferable several months, without appreciable glass delamination. For example, the product is free of glass particulate as the result of glass delamination for at least three months, more particularly, 6 months, even more particularly 12, 18, 24, 30 or 36 months without measurable delamination.

Another aspect of the invention relates to a method for storing an aqueous iron sucrose formulation. The method includes providing a glass vessel having an inside surface coated with a layer of material comprising a silicone polymer or silicon dioxide. The glass vessel and the layer of the material can be substantially as described above with respect to the packaged iron sucrose product of the present invention. The method further comprises at least partially filling the glass vessel with the aqueous iron sucrose formulation. The aqueous iron sucrose formulation can be substantially as described above with respect to the packaged iron sucrose products of the present invention. In certain embodiments of the invention, the glass vessel is then sealed, for example with a cap or stopper of known construction. The cap or stopper preferably has a product contact surface constructed from a material that does not interact with the iron sucrose contained within the container. In one aspect of the invention, the cap or stopper has a product contact surface that includes a layer of material substantially as described above with respect to the container.

In FIG. 1, the container 12 has a closure (shown as cap 22) constructed to seal opening 20, thereby fluidly sealing the iron sucrose formulation 16 within container 12. Cap 22 can be constructed of a variety of known materials. However, it is preferable that cap 22 be constructed of a material that minimizes the transmission of vapor therethrough and that minimizes the likelihood of interaction with and/or degradation of formulation 18. For instance, cap 22 is a material having vapor barrier characteristics sufficient to minimize the transmission of atmospheric components therethrough. The inner surface of the cap, stopper, lid or cover can be formed from or coated by a base-resistant material, such as polymethylpentene or fluoropolymer. Cap 22 and container 12 can be constructed such that cap 22 can be threadingly secured thereto. Containers and caps of this type are well known. Alternative embodiments of cap 22 and container 12 are also possible and will be immediately recognized by those of ordinary skill in the relevant art. Such alternative embodiments include, but are not necessarily limited to, caps that can be “snap-fit” on containers, caps that can be adhesively secured to containers, and caps that can be secured to containers using known mechanical devices, e.g., a ferrule. In one embodiment of the present invention, cap 22 and container 12 are configured such that cap 22 can be removed from container 12 without causing permanent damage to either cap 22 or container 12, thereby allowing a user to reseal opening 20 with cap 22 after the desired volume of formulation 18 has been removed from container 12. In another embodiment of the present invention, cap 22 is constructed as a stopper for a pharmaceutical vial, thereby allowing medical personnel to access the contents of container 12 by inserting a hypodermic needle through cap 22. In this embodiment, cap 22 is constructed of a material that substantially seals itself upon removal of a hypodermic needle that has been inserted therethrough in order to access the contents of container 12.

The purpose of container 12 is to contain formulation 18. In the embodiment depicted in FIG. 1, container 12 is in the shape of a bottle or standard pharmaceutical vial. However, it will be appreciated that container 12 can have a variety of configurations, closures and volumes without departing from the spirit and scope of the invention. For example, container 12 can be configured as a shipping vessel for large volumes (e.g., tens or hundreds of liters) of formulation 18. Such shipping vessels can be rectangular, spherical, or oblong in cross-section without departing from the intended scope of the invention. The glass vessel can have any desired form. For example, the glass vessel can have the shape of a vial. The vial can have, for example, a capacity in the range of 1 mL to 30 mL. In other embodiments of the invention, the glass vessel has the foam of an ampoule. The glass vessel can have other forms, such as a tube, a bottle, a jar, or a flask. In other embodiments of the invention, the glass vessel is a syringe. In certain embodiments, any headspace in the glass vessel can be charged with a non-oxidizing gas, such as nitrogen or argon.

The following example is provided for exemplification purposes only and is not intended to limit the scope of the invention described in broad terms above.

### EXAMPLES

### Example 1

A glass delamination study was performed under accelerated stability conditions. An iron sucrose solution (20 mg elemental iron and 300 mg sucrose per ml of water) at pH 11.0 was packaged in the containers along with a control wherein delamination is expected. Four different coated containers were evaluated to determine prevention of delamination under various packaging conditions. Molded glass vials (Wheaton Science Products, Milleville, N.J.), and glass tubing vials (Schott AG). were coated with silicone by rinsing the containers with the DOW CORNING® 365 Medical Fluid and baking the containers for a predetermined time and temperature. A third container was a CARPUJECT® syringe (Hospira, Inc., Lake Forest, Ill.). The syringe has a siliconized glass surface that is prepared by spraying the DOW CORNING® 365 medical fluid on the interior of the syringe and baking. The fourth container was a container of Schott TYPE 1 PLUS® tubing glass (Schott, AG), which is prepared with a pure silicon dioxide coating. The control was a container made of conventional, non-coated tubing glass from Gerresheimer AG (Dusseldorf, Germany).

Five containers of each type containing an iron sucrose formulation were stored at 25 and 40° C. Glass delamination in each of the containers was assessed by filtering the solution using a polycarbonate filter and observing the glass flakes under scanning electron microscopy. Particulates identified as glass were further tested for elemental analysis. The presence of sodium, potassium, oxygen, aluminum and silicon was deemed to be indicative of delamination.

As presented in Table 1, the data show that delamination occurred when the product was packaged in uncoated tubing glass. Wheaton (siliconized) glass, Schott (siliconized) glass, and Carpuject® (siliconized) glass syringes did not show evidence of delamination. Containers of Schott TYPE 1 PLUS® glass showed some evidence of delamination, but not as significant as that of the control.

TABLE 1

| | | SEM Data | | SEM Data | | SEM Data | |
|---|---|---|---|---|---|---|---|
| Container | SEM data | 1 Month | | 2 Month | | 3 Month | |
| Type | (Initial) | 25° C. | 40° C. | 25° C. | 40° C. | 25° C. | 40° C. |
| Tubing vials | 3 out of 5 | No | No | All 5 vials | All 5 vials | NT | NT |
| (uncoated | vials had | flakes | flakes | contain | contain flakes. | (Not | |
| control) | several | | | flakes. | Flake size | Tested) | |
| | thin flakes | | | Flake size > | ranges from | | |
| | between | | | 100 microns. | 100 microns | | |
| | 200-500 | | | Number of | to 1 mm. Number | | |
| | microns | | | flakes range | of flakes range | | |
| | | | | from 2 to | from 10 to 50 | | |
| | | | | 100 based on | based on vial. | | |
| | | | | vial. | | | |
| Wheaton | No | No | No | No flakes | No flakes | NT | No |
| Siliconized | flakes | flakes | flakes | | | | flakes |
| (Molded) | | | | | | | |
| SCHOTT | One flake | One | No | No flakes | No flakes | NT | No |
| Siliconized | about 100 | flake | flakes | | | | flakes |
| (Tubing) | microns | about | | | | | |
| | | 20 μM | | | | | |
| CARPUJECT ® | One flake | No | No | No Flake | NT | NT | No |
| | about 50 | Flake | Flake | | | | flakes |
| | microns | | | | | | |
| SCHOTT | No | No | No | All five vials | No flakes | NT | NT |
| TYPE I | flakes | flakes | flakes | contain | | | |
| PLUS ® | | | | flakes > 100 | | | |
| (Tubing) | | | | microns. | | | |
| | | | | Number of | | | |
| | | | | flakes range | | | |
| | | | | from 2-15 | | | |
| | | | | based on vial. | | | |

### Example 2

In three additional studies, samples of Iron Sucrose Injection were prepared as described above and packaged in glass CARPUJECT® syringe containers that were coated with a silicone polymer as described in Example 1. The samples were subject to both accelerated and long term stability storage. Five units of each sample were collected at various time points and analyzed for glass flakes as described above. As shown in Table 2, some delamination was found in all samples stored at accelerated 40° C. storage after 6 months. However, as shown in Table 3, no delamination was found in all samples at 25° C. and 30° C. at 12 months of storage, and minimal delamination was found after 18 months of storage.

TABLE 2

| Time point/Storage | Iron Sucrose Injection | | |
|---|---|---|---|
| Condition | Sample A | Sample B | Sample C |
| Initial | No delamination | No delamination | No delamination |
| 1M 40° C./75% RH | No delamination | No delamination | No delamination |
| 2M 40° C./75% RH | No delamination | No delamination | No delamination |
| 3M 40° C./75% RH | No delamination | No delamination | Flakes were found in 1 |
| | | | out of 5 syringe |
| | | | cartridges. Approx. 6 |
| | | | flakes measuring 10-100 |
| | | | μm in length. |
| 6M 40° C./75% RH | Very thin flakes were | Very thin flakes were | Some thicker particles |
| | found in 2 out of 5 | found in 2 out of 5 | were found in 2 out of 5 |
| | syringe cartridges; | syringe cartridges; 10- | syringe cartridges; 15-60 |
| | 10-30 μm in length. | 200 μm in length. One | μm in length. No |
| | One cartridge had 4 | cartridge had about 12 | definite evidence of glass |
| | and the other had 2 | flakes and the other had | delamination. |
| | flakes. | about 8 flakes. | |

TABLE 3

| | | | |
|---|---|---|---|
| 9M 30° C./65% RH | No delamination | No delamination | 1 of 5 cartridges showed |
| | | | a single flake of about 10 |
| | | | μm in length. |
| 12M 25° C./60% RH | No delamination | No delamination | 1 possible flake about |
| | | | 100 μm in length was |
| | | | found. Inconclusive for |
| | | | delamination because the |
| | | | thickness of the flake is |
| | | | not characteristic of |
| | | | typical delamination. |
| 12M 30° C./65% RH | No delamination | No delamination | No delamination |
| 18M 25° C./60% RH | Very thin glass flakes | Very thin glass flakes | Very thin glass flakes |
| | were found in 2 out of | were found in 4 out of 5 | were found in 3 out of 5 |
| | 5 syringe cartridges, | syringe cartridges, 20- | syringe cartridges, 5-50 |
| | 20-100 μm in length. | 100 μm in length. Two | μm in length. One |
| | One cartridge had | cartridges had about 20 | cartridge had 6 flakes |
| | about 20 flakes and | flakes each and the other | and the other two had |
| | the other one had 15 | 2 had about 5 flakes. | one flake each. |
| | flakes. | | |
| 18M 30° C./65% RH | No delamination | No delamination | Very thin glass flakes |
| | | | were found in 3 out of 5 |
| | | | syringe cartridges, 20-80 |
| | | | μm in length. One |
| | | | cartridge had about 30 |
| | | | flakes other one had |
| | | | about 12 and the third |
| | | | cartridge had about 3 |
| | | | flakes. |

Although various specific embodiments of the present invention have been described herein, it is to be understood that the invention is not limited to those precise embodiments and that various changes or modifications can be affected therein by one skilled in the art without departing from the scope and spirit of the invention.

28. A packaged iron sucrose product comprising:
(a) a container constructed from a material comprising glass, the container having an inside surface having formed thereon a layer of a material comprising a silicone polymer; and
(b) an iron sucrose formulation inside the container in contact with the layer of the material, wherein the formulation has a pH greater than 10,
wherein the solution is substantially free of glass flakes as a result of glass delamination for at least three months.

29. The packaged iron sucrose product of claim 28, wherein the formulation is an aqueous formulation.

30. The packaged iron sucrose product of claim 28, wherein the container is a syringe.

31. The packaged iron sucrose product of claim 28, wherein the formulation has an iron concentration in a range of 0.1 mg/mL to 50 mg/mL.

32. The packaged iron sucrose product of claim 28, wherein the silicone polymer is a polyalkylsiloxane.

33. The packaged iron sucrose product of claim 28, wherein the silicone polymer is polydimethylsiloxane.

34. The packaged iron sucrose product of claim 29, wherein the formulation consists essentially of iron sucrose and water for injection.

35. The packaged iron sucrose product of claim 32, wherein the layer of the polyalkylsiloxane has a thickness in the range of about 150 nm to about 50 μm.

36. The packaged iron sucrose product of claim 28, wherein the iron sucrose formulation is free of glass flakes as the result of glass delamination for at least six months.

37. An iron sucrose product comprising a container comprising a glass surface defining the interior of the container in contact with an iron sucrose formulation having a pH of 10 or greater, wherein the surface is coated with a material comprising a silicone polymer, wherein the solution is substantially free of glass flakes as a result of glass delamination for at least three months.

38. The iron sucrose product of claim 37, wherein the formulation is an aqueous formulation.

39. The packaged iron sucrose product of claim 37, wherein the container is a syringe.

40. The iron sucrose product of claim 37, wherein the formulation has an iron concentration in the range of 0.1 mg/mL to 50 mg/mL.

41. The iron sucrose product of claim 37, wherein the silicone polymer is a polyalkylsiloxane.

42. The iron sucrose product of claim 37, wherein the silicone polymer is polydimethylsiloxane.

43. The iron sucrose product of claim 37, wherein the aqueous iron sucrose formulation is free of glass flakes as the result of glass delamination for at least six months.

44. A method for storing an aqueous iron sucrose formulation, comprising
(a) providing a container constructed from a material comprising glass, the container having an inside surface having formed thereon a layer of a material comprising a silicone polymer; and
(b) at least partially filling the container vessel with the aqueous iron sucrose formulation having a pH of at least 10;
(c) storing the mixture in the container, wherein the solution is substantially free of glass flakes as a result of glass delamination for at least three months at room temperature.

45. The method of claim 44, wherein the container is a syringe.

46. A method of preventing glass delamination resulting in glass flakes during the storage for at least three months of a glass container that contains an iron sucrose formulation having a pH of 10 or greater, the method comprising coating an inside surface of the glass container that contacts the formulation with a silicone polymer.

47. The method of claim 46, wherein the container is a syringe.

48. The method of claim 46, wherein the storage is for at least six months.

49. The method of claim 46, wherein the storage is for at least nine months.
